(19) United States
(12) Patent Application Publication
(10) Pub. No.: US 2008/0078624 A1
(43) Pub. Date: Apr. 3, 2008

(54) VERTICAL CONVEYOR WITH HYDRAULIC DRIVE

(75) Inventor: Mark R. Webster, Hubertus, WI (US)

Correspondence Address: MICHAEL BEST & FRIEDRICH LLP, 100 E WISCONSIN AVENUE, Suite 3300, MILWAUKEE, WI, 53202, US

(73) Assignee: PFLOW INDUSTRIES, INC., Milwaukee, WI (US)

(21) Appl. No.: 11/460,374

(22) Filed: Jul. 27, 2006

(51) Int. Cl. B66B 9/04

(52) U.S. Cl. 187/274; 187/272

(57) ABSTRACT

A vertical conveyor that includes a frame, a carriage, and a drive mechanism. The frame includes a vertical support member, and the carriage is coupled to the frame to carry a load. The carriage is mounted for movement along the vertical support member. The drive mechanism includes a first actuator and a second actuator. The first actuator includes a cylinder and a rod that extends from the cylinder to raise the carriage. The second actuator includes a cylinder and a rod each having lengths greater than lengths of the cylinder and rod of the first actuator. The rod of the second actuator extends from the cylinder of the second actuator to raise the carriage and the cylinder of the first actuator.

### BACKGROUND

The present invention relates to a vertical conveyor that can be employed in warehouses, factories, and the like to convey material or cargo between different vertical levels.

A typical vertical conveyor includes a carriage mounted for vertical movement on a frame or supporting structure and that is adapted to support cargo. In some types of vertical conveyors, the carriage is either straddled between two vertical columns of the frame or is cantilevered outward from the columns and guided for vertical movement on the columns. The carriage is lifted by a pulling force from at least one hydraulic cylinder having an upper end secured near the top of the conveyor (e.g., to the top of a column or to a ceiling) and a lower end secured to the carriage. In operation, the hydraulic cylinder retracts to pull the carriage upward.

### SUMMARY

The present invention provides a vertical conveyor that includes a frame, a carriage, and a drive mechanism. The frame includes a vertical support member, and the carriage is coupled to the frame to carry a load. The carriage is mounted for movement along the vertical support member. The drive mechanism includes a first actuator and a second actuator. The first actuator includes a cylinder and a rod that extends from the cylinder to raise the carriage. The second actuator includes a cylinder and a rod having lengths greater than lengths of the cylinder and rod of the first actuator. The rod of the second actuator extends from the cylinder of the second actuator to raise the carriage and the cylinder of the first actuator.

In another embodiment, the present invention provides a vertical conveyor that includes a frame, a carriage, a first actuator, and a second actuator. The frame includes a vertical support member, and the carriage is coupled to the frame to carry a load. The carriage is mounted for movement along the vertical support member. The first actuator includes a cylinder and a rod that extends from the cylinder. The second actuator includes a cylinder and a rod that extends from the cylinder of the second actuator, and wherein the cylinder of the first actuator is coupled to the cylinder of the first actuator in a side-by-side relation.

In another embodiment the invention provides a method of raising a carriage from a lowered position to a raised position. The carriage is coupled to a frame for movement along a vertical support member of the frame. The method includes raising the carriage from the lowered position to an intermediate position by extending one of a first actuator and a second actuator. The method further includes raising the carriage from the intermediate position to the raised position by extending the other of the first actuator and the second actuator, the first actuator including a cylinder having a length and the second actuator including a cylinder having a length that is greater than the length of the cylinder of the first actuator.

Other aspects of the invention will become apparent by consideration of the detailed description and accompanying drawings.

### BRIEF DESCRIPTION OF THE DRAWINGS

FIG. 1a is a front perspective view of a vertical conveyor embodying the present invention with a carriage in a lowered position.

FIG. 1b is a front perspective view of the vertical conveyor shown in FIG. 1a with the carriage in an intermediate position.

FIG. 1c is a front perspective view of the vertical conveyor shown in FIG. 1a with the carriage in a raised position.

FIG. 2 is a perspective view of the carriage of FIG. 1a.

FIG. 3 is a section view taken along line 3-3 of FIG. 1a.

FIG. 4 is a partial front view of the vertical conveyor shown in FIG. 1a.

FIG. 5 is a section view taken along line 5-5 of FIG. 1a.

FIG. 6 is an enlarged perspective view taken at line 6-6 of FIG. 1a.

FIG. 7 is a front perspective view of an alternative construction of the vertical conveyor shown in FIG. 1a with the carriage in the raised position.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,”“supported,” and “coupled” and variations thereof are used broadly and encompass both direct and indirect mountings, connections, supports, and couplings. Further, “connected” and “coupled” are not restricted to physical or mechanical connections or couplings.

### DETAILED DESCRIPTION

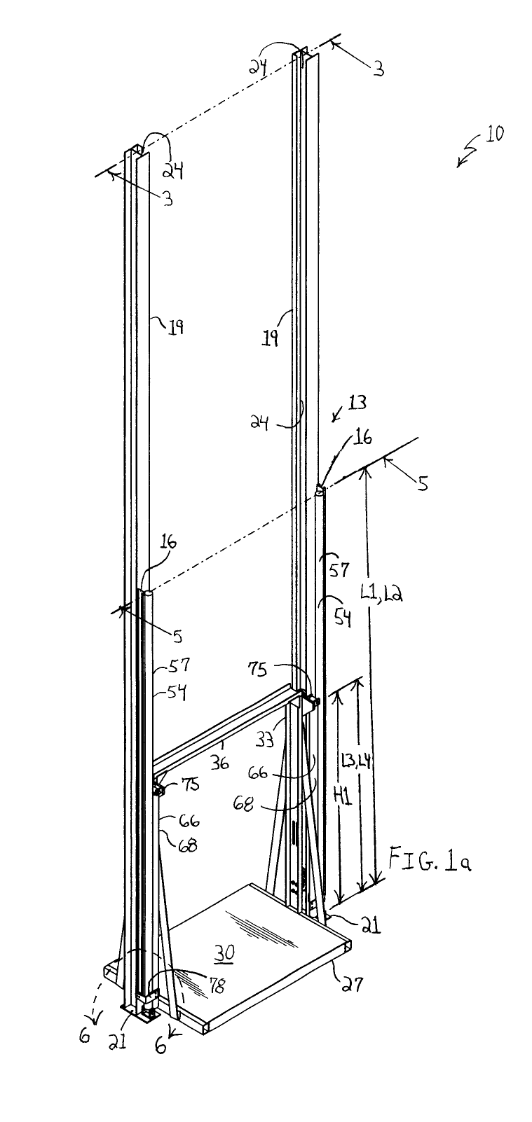

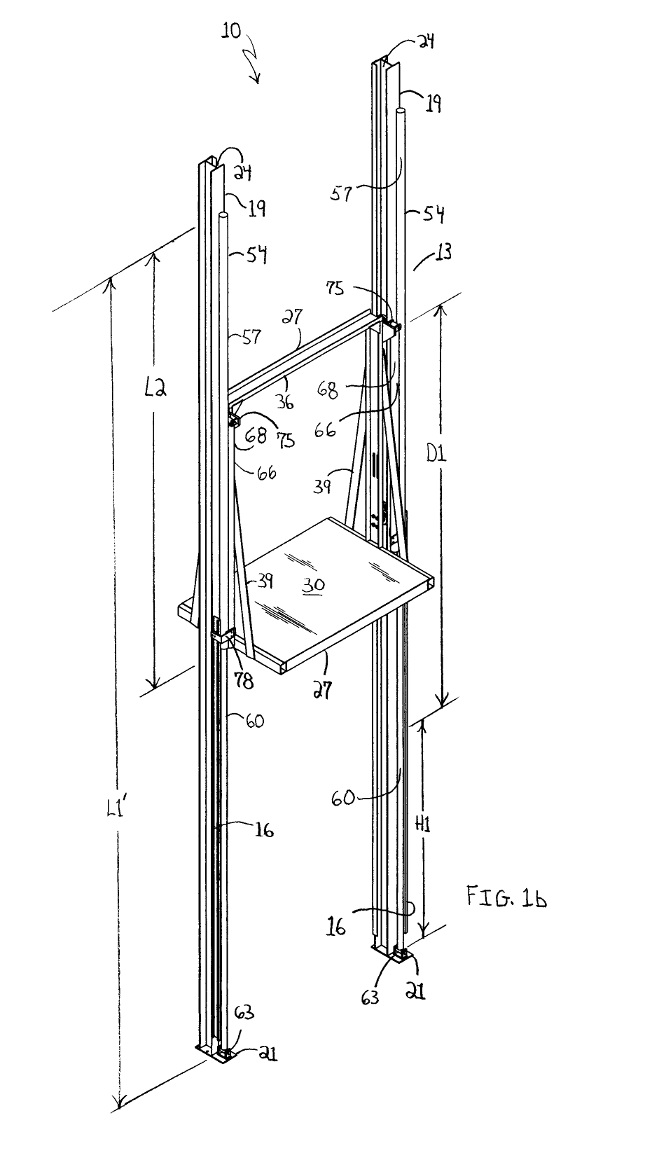

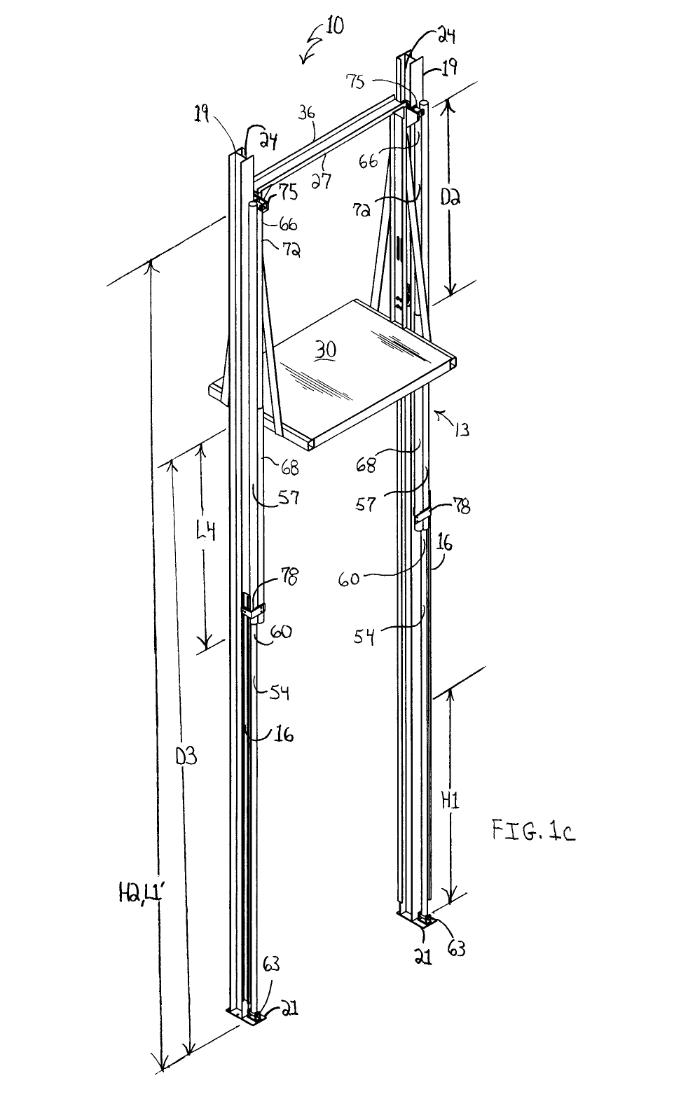

FIG. 1a illustrates a vertical conveyor 10 that is adapted to move materials or cargo between different vertical levels. For example, the vertical conveyor 10 can move materials from a lower floor or level to an upper floor or level. The vertical conveyor 10 includes a frame 13 having vertical support members that include both short vertical supports 16 and long vertical supports 19. While the illustrated conveyor 10 includes both the long and short supports 19, 16 in other constructions the conveyor may include vertical supports that are generally the same length.

The lower ends of the short and long vertical supports 16, 19 are supported by bases 21. The bases 21 can be coupled to a foundation or floor using anchor bolts, a welded connection, and the like. The frame 13, the bases 21, and the long and short vertical supports 19, 16 can be formed from any suitable material, such as aluminum, steel, plastic, etc.

The long vertical supports 19 can be formed with the base 21, or can be coupled to the base 21 through the use of fasteners, welded connections, and the like. In the illustrated embodiment, the long vertical supports 19 are modified I-beams that define a channel 24. While the illustrated conveyor 10 includes a pair of long supports 19, in other constructions the conveyor can include one or more than two long supports.

The short vertical supports 16 can be integrally molded, fastened, or welded to the bases 21 and/or the long vertical supports 19. The illustrated short vertical supports 16 define a channel with a generally C-shaped cross section. While the illustrated short vertical supports 16 are coupled to a side, or a flange, of the long vertical supports 19, in other constructions, the short vertical supports 16 can be coupled to other locations. Furthermore, while the illustrated conveyor 10 includes a pair of short supports 16, in other constructions the conveyor may include one or more than two short supports.

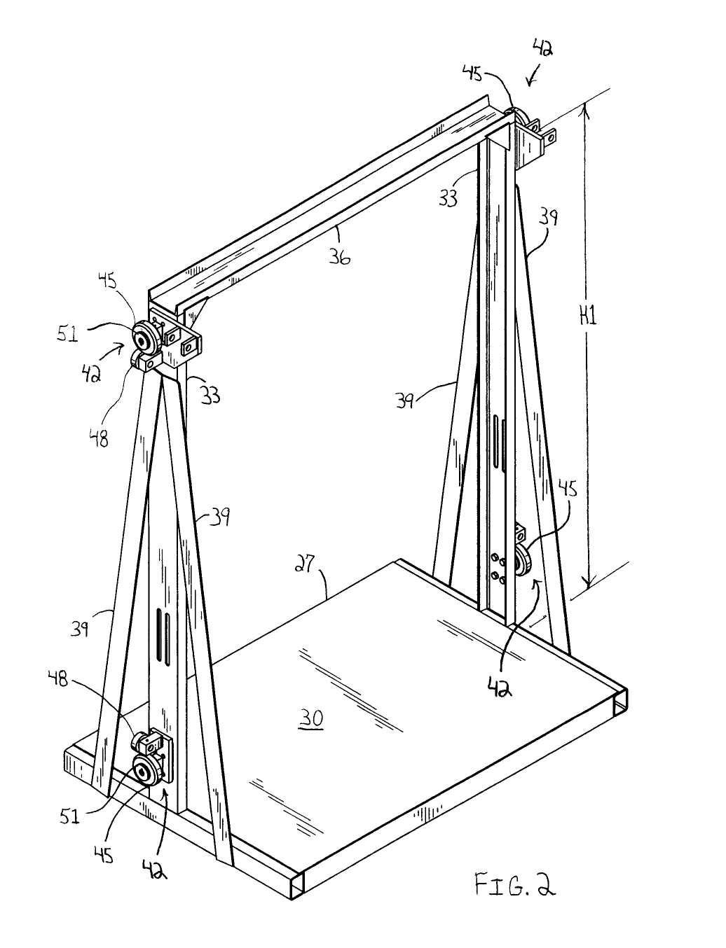

The vertical conveyor 10 also includes a carriage 27 having a height H1. Referring to FIG. 2, the carriage 27 includes a generally flat platform 30 adapted to support a load or cargo. The carriage 27 also includes side supports 33 for supporting the carriage 27. The side supports 33 are connected by a top support 36 to help stabilize the carriage 27, and reinforcing supports 39 are secured between the platform 30 and the side supports 33 and are angled to stabilize the carriage 27 and help the carriage 27 to accommodate excessive torque due to an uneven load.

With continued reference to FIG. 2, the illustrated carriage 27 includes four sets of wheels or rollers 42. Each set of rollers 42 includes a first roller 45 and a second roller 48. The first roller 45 is journaled on a shaft 51 that extends generally normal from the side support 33. The second roller 48 is coupled to the side support such that the second roller rotates about an axis that is generally normal the shaft 51 of the first roller 45.

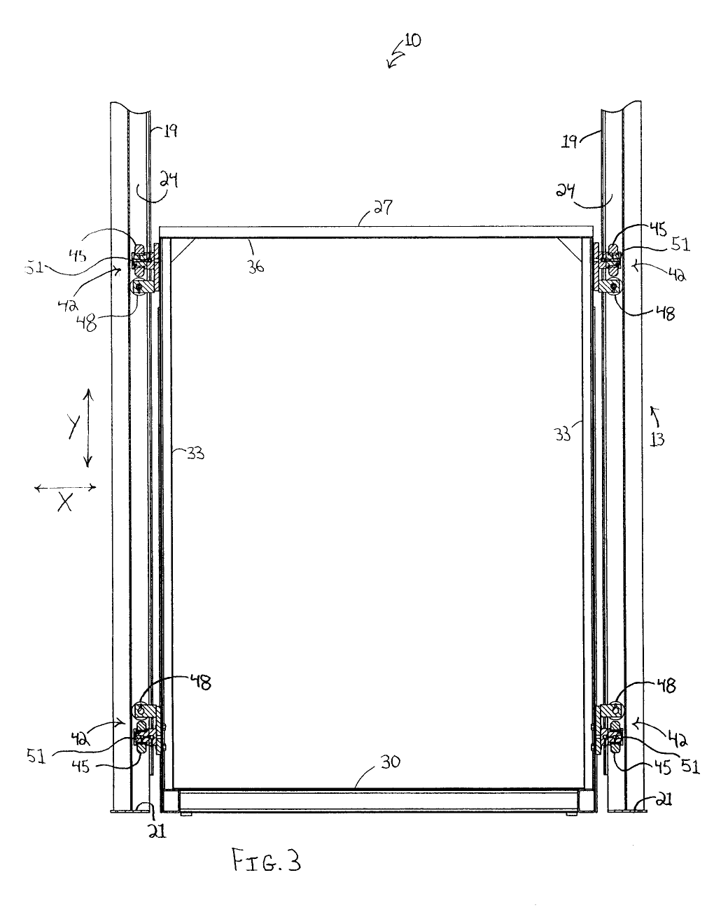

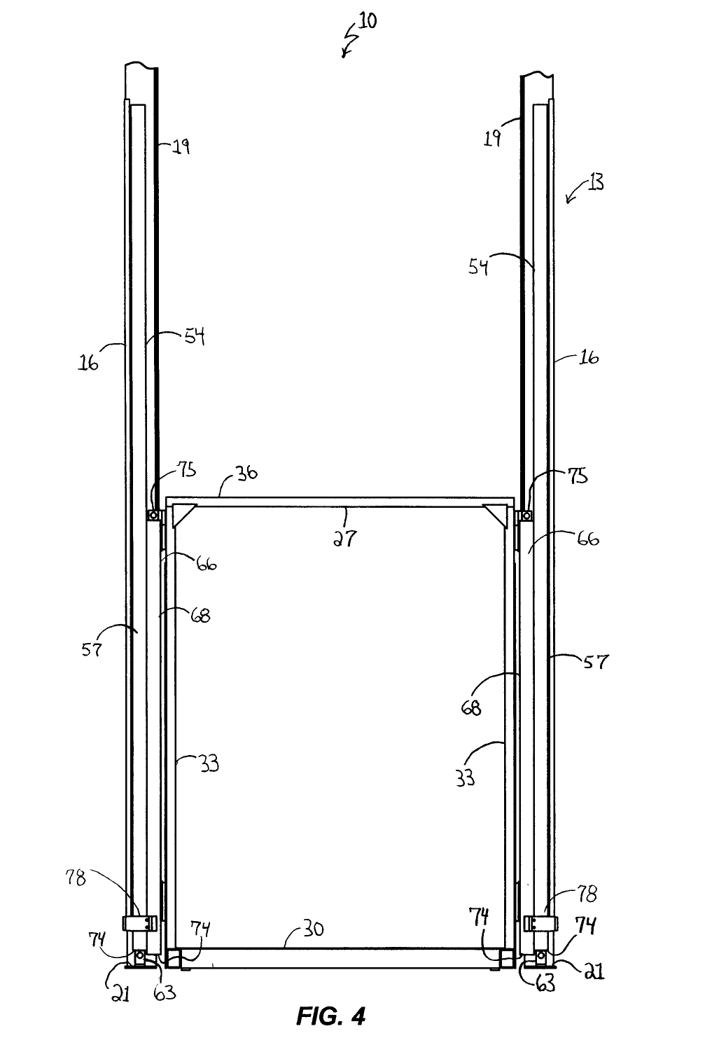

Referring to FIGS. 3 and 4, the carriage 27 is placed between the short and long vertical supports 16, 19 of the vertical conveyor 10. As illustrated in FIG. 3, the first and second rollers 45, 48 of the carriage 27 are located within the channel 24 of the long vertical support 19. The first and second rollers 45, 48 roll along inside surfaces of the channels 24 to allow the carriage 27 to travel in the directions indicated by the arrows Y, and to substantially prevent movement, or stabilize, the carriage 27 in directions indicated by the arrows X.

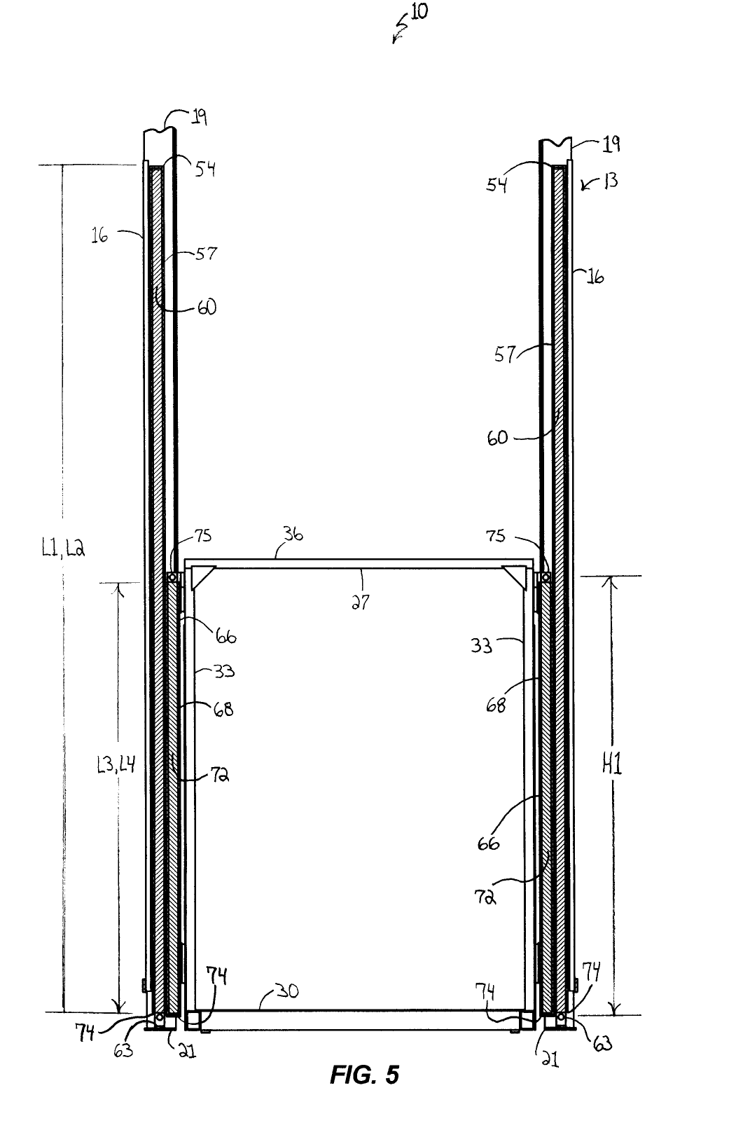

Referring to FIG. 5, the vertical conveyor 10 further includes a pair of long hydraulic actuators 54 having a length L1 and positioned on opposing sides of the carriage 27. Each long hydraulic actuator 54 includes a long cylinder 57 and a long rod 60 connected to a piston inside the long cylinder 57. A lower end of each long rod 60 is secured to the base 21 using a lower clevis mount 63. The long cylinders 57 have a length L2 and, because FIG. 5 illustrates the long actuator 54 in a retracted position (i.e., minimum length), the length L1 of the long actuators 54 are approximately equal to the length L2 of the long cylinders 57. The piston is configured to extend the long rod 60 out of the long cylinder 57 to change the length L1 of the long hydraulic actuator 54, and the illustrated long hydraulic actuator 54 can extend to a maximum length that is approximately equal to the twice the length L2 of the long cylinder 57.

A pair of short hydraulic actuators 66 having a length L3 are positioned on opposing sides of the carriage 27 and adjacent to a corresponding long hydraulic actuator 54. Each short hydraulic actuator 66 includes a short cylinder 68 and a short rod 72 connected to a piston inside the short cylinder 68. In the illustrated construction each short cylinder 68 is coupled to the adjacent long cylinder 57 in a side-by-side relationship. Furthermore, the cylinders 68, 57 of the short and long actuators 66, 54 each include a lower end 74, and in the illustrated construction the lower ends 74 of the cylinders 68, 57 are adjacent each other. The upper end of each short rod 72 is coupled to an upper flange of the carriage 27 using an upper clevis mount 75.

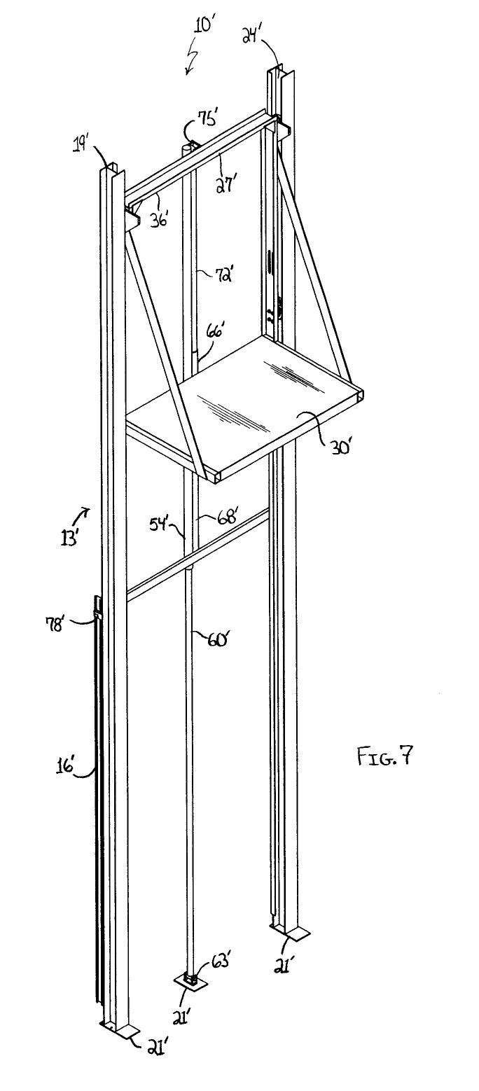

While the illustrated vertical conveyor 10 of FIGS. 1a-6 includes the pair of short hydraulic actuators 66 and the pair of long hydraulic actuators 54, in other constructions the vertical conveyor can include any suitable number of long and short hydraulic actuators 54, 66. For example, FIG. 7 illustrates a vertical conveyor 10′ that includes one long hydraulic actuator 54′ and one short hydraulic actuator 66′. The remaining parts of the vertical conveyor 10′ are substantially similar to the vertical conveyor 10, and like parts have been given the same reference number plus a prime symbol.

The illustrated short cylinders 68 have a length L4 and, because FIG. 5 illustrates the short actuators 66 in a retracted position (i.e., minimum length), the length L3 of the short actuators 66 are approximately equal to the length L4 of the short cylinders 68. The piston is configured to extend the short rod 72 out of the short cylinder 68 to change the length L3 of the short hydraulic actuator 66. The illustrated short hydraulic actuator 66 can extend to a maximum length that is approximately equal to the twice the length L4 of the short cylinder 68.

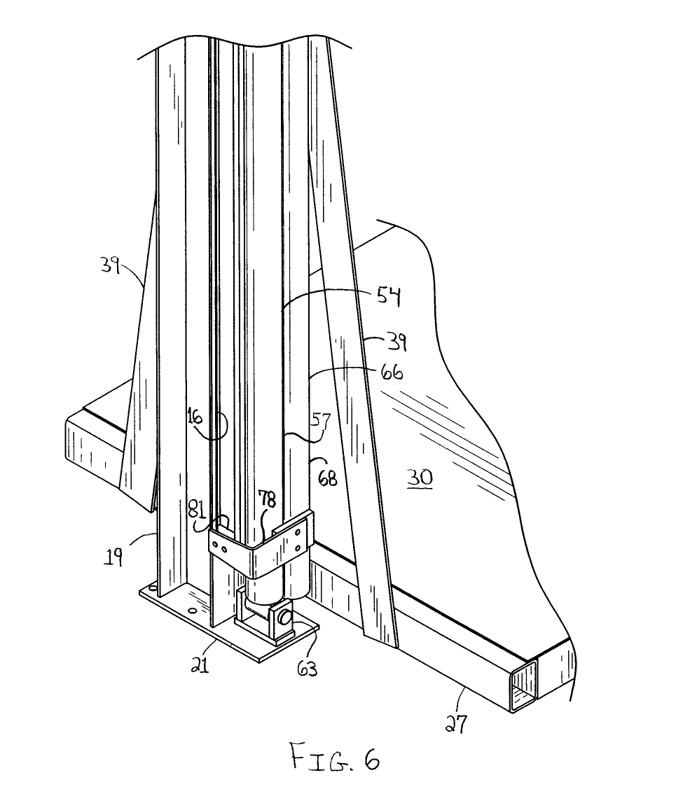

Referring to FIG. 4, a guide flange 78 is secured to each pair of short and long cylinders 68, 57. FIG. 6 illustrates and enlarged view of one of the guide flanges 78. Each guide flange 78 includes an anti-friction pad 81 that is slidably supported within the c-shaped channel of the corresponding short vertical support 16. The anti-friction pad 81 can be formed from, or coated with, any suitable material, such as TEFLON, graphite, and the like, to reduce the friction between the pad 81 and the short vertical support 16. In other constructions, the guide flange 78 may include a wheel, roller, or other suitable device alone or in combination with the pad 81. The pad 81 and guide flange 78 provide guidance to the lower ends of the short and long cylinders 68, 57.

While operation of the vertical conveyor will be described with reference to the vertical conveyor 10 of FIGS. 1a-6, it should be understood that the operation of the vertical conveyor 10′ of FIG. 7 is substantially the same as the operation of the vertical conveyor 10.

In operation, the carriage 27 is moved from a lowered position (FIG. 1a) to a raised position (FIG. 1c) by actuating the long hydraulic actuators 54 and the short hydraulic actuators 66 to change their lengths L1, L3. This can occur by actuating all of the hydraulic actuators simultaneously so that both the short hydraulic actuators 66 and the long hydraulic actuators 54 extend the rods 60, 72 from the cylinders 57, 68 at generally the same time. Alternatively, one pair of hydraulic actuators (either the pair of short hydraulic actuators 66 or the pair of long hydraulic actuators 54) can be actuated first, followed by actuation of the other pair of hydraulic actuators.

In the illustrated embodiment, the long hydraulic actuators 54 are actuated first, resulting in the carriage 27 moving from the lowered position (FIG. 1a) to an intermediate position (FIG. 1b). During actuation of the long hydraulic actuators 54, the long rods 60 are forced out of the long cylinders 57, resulting in the long cylinders 57 being raised. Because the long cylinders 57 are secured to the short cylinders 68, and further because the short cylinders 68 are coupled to the carriage 27, the carriage 27 is raised a distance D1 that is approximately equal to the length L2 of the long cyclinders 57 when the long hydraulic actuators 54 are extended to their maximum length L1′.

After the long hydraulic actuators 54 have been fully actuated, the short hydraulic actuators 66 are actuated to raise the carriage 27 from the intermediate position (FIG. 1b) to the raised position (FIG. 1c). During this process, the short rods 72 are extended upwardly from the short cylinders 68. Because the upper ends of the short rods 72 are secured to the carriage 27, the carriage is raised an additional distance D2 that is approximately equal to the length L3 of the short cylinders 68. Therefore, the top of the carriage 27 has been raised to a height H2 that is approximately equal to twice the length L2 of the long cylinders 57 or approximately equal to the maximum length L1′ of the long hydraulic actuators 54. The carriage 27 can then be lowered by reversing actuation of the hydraulic actuators 54, 66.

Referring to FIG. 1c, the illustrated arrangement of the long and short hydraulic actuators 54, 66 allows the user to raise the carriage platform 30 a total distance D3 that is approximately equal to the length L2 of the long cylinders 57 (FIG. 1a) plus the length L4 of the short cylinders 68. Furthermore, the illustrated arrangement of the long and short hydraulic actuators 54, 66 allows the user to raise the platform 30 the distance D3 while the maximum length L1′ of the long hydraulic actuators 54 is approximately equal to the height H2 of the top of the carriage 27 at the raised position. In one application, the vertical conveyor 10 can be utilized in a building having a roof or ceiling, and because the long hydraulic actuators 54 generally do not extend above the carriage 27 in the raised position, the amount of overhead distance between the roof or ceiling and the vertical conveyor 10 is reduced when compared to vertical conveyors that utilize actuators that extend above the carriage in the raised position.

In one application of the vertical conveyor 10, it is desirable to maximize the height H1 of the carriage 27, which would be approximately equal to the distance between the ceiling and the uppermost floor that the vertical conveyor reaches. Utilizing the illustrated vertical conveyor 10, with the long and short hydraulic actuators 54, 66, the maximum travel of the platform 30 is the distance D3 that is approximately equal to three times the height H1 of the carriage 27. Whereas, if the vertical conveyor utilized hydraulic actuators of equal length, the maximum travel of the platform would only be twice the height H1 of the carriage 27.

While the illustrated vertical conveyor is only shown with the carriage 27 in three positions, the lowered position (FIG. 1a), the intermediate position (FIG. 1b), and the raised position (FIG. 1c), it should be understood that the vertical conveyor 10 can be operated to position the carriage 27 at any location between the lowered position (FIG. 1a) and the raised position (FIG. 1c).

In one construction of the conveyor 10, all of the hydraulic actuators 54, 66 are provided with pressurized hydraulic fluid from a common source. In one such construction, the short hydraulic actuators 66 have the same diameter as the long hydraulic actuators 54, thus resulting in approximately the same force being provided when pressurized hydraulic fluid is supplied. In this construction, the short hydraulic actuators 66 are lifting the weight of the carriage 27 and cargo, while the long hydraulic actuators 54 are lifting the weight of the carriage 27, the cargo, the short hydraulic actuators 66, and the long cylinders 57. As a result, when the pressurized hydraulic fluid is provided to all of the hydraulic actuators 54, 66, the short hydraulic actuators 66 will start moving first due to the hydraulic fluid seeking the path of least resistance. After the short hydraulic actuators 66 have been fully extended, the hydraulic fluid will move the long hydraulic actuators 54 resulting in extension of the long rods 60.

What is claimed is:

1. A vertical conveyor comprising:
a frame including a vertical support member;
a carriage coupled to the frame to carry a load, the carriage mounted for movement along the vertical support member; and
a drive mechanism including,
a first actuator including a cylinder and a rod that extends from the cylinder to raise the carriage to a height that is substantially equal to twice a height of the carriage; and
a second actuator including a cylinder and a rod having lengths greater than lengths of the cylinder and rod of the first actuator, wherein the rod of the second actuator extends from the cylinder of the second actuator to raise the carriage and the cylinder of the first actuator, and wherein the second actuator raises the carriage to a height that is substantially equal to twice the length of the cylinder of the second actuator after the carriage is completely raised by the first actuator.

2. The vertical conveyor of claim 1, wherein the cylinders of the first and second actuators are coupled in a side-by-side relationship.

3. The vertical conveyor of claim 1, wherein the frame includes a base, and wherein the rod of the second actuator includes an end that is coupled to the base.

4. The vertical conveyor of claim 1, wherein the carriage includes an upper support member, and wherein the rod of the first actuator includes an end coupled to the upper support member.

5. The vertical conveyor of claim 1, wherein the cylinders of the first and second actuators each include a lower end, and wherein the cylinders of the first and second actuators are aligned such that the lower ends are adjacent.

6-7. (canceled)

8. The vertical conveyor of claim 1, wherein the first and second actuators are hydraulically driven.

9. The vertical conveyor of claim 1, further comprising a pair of first actuators and a pair of second actuators.

10. The vertical conveyor of claim 1, wherein the vertical support member includes a pair of long vertical supports and a pair of short vertical supports.

11-14. (canceled)

15. A method of raising a carriage from a lowered position to a raised position, the carriage coupled to a frame for movement along a vertical support member of the frame, the method including:
raising the carriage from the lowered position to an intermediate position by extending one of a first actuator and a second actuator; and
raising the carriage from the intermediate position to the raised position by extending the other of the first actuator and the second actuator, the first actuator including a cylinder having a length and the second actuator including a cylinder having a length that is greater than the length of the cylinder of the first actuator.

16. The method of claim 15, wherein the distance between the lowered position and the intermediate position is substantially equal to the length of the cylinder of one of the first and second actuators.

17. The method of claim 15, wherein the distance between the lowered position and the raised position is substantially equal to the length of the cylinder of the first actuator plus the length of the cylinder of the second actuator.

18. The method of claim 15, wherein extending the second actuator includes extending a rod from the cylinder of the second actuator, and wherein the rod of the second actuator includes an end coupled to a base of the frame.

19. The method of claim 15, wherein extending the first actuator includes extending a rod from the cylinder of the first actuator, and wherein the rod of the first actuator includes an end coupled to the carriage.

20. The method of claim 15, wherein extending the second actuator includes raising the cylinder of the first actuator.
